(19) United States
(12) Patent Application Publication
(10) Pub. No.: US 2023/0119403 A1
(43) Pub. Date: Apr. 20, 2023

(54) ANGULATED SCREW CHANNEL FOR DENTAL IMPLANT

(71) Applicant: BIOMET 3I, LLC, Palm Beach Gardens, FL (US)

(72) Inventors: Werner Weithaler, Postal (IT); Andreas Geier, Gargazon (IT)

(21) Appl. No.: 17/566,365

(22) Filed: Dec. 30, 2021

Related U.S. Application Data
(60) Provisional application No. 63/270,021, filed on Oct. 20, 2021.

(51) Int. Cl. A61C 13/00; A61C 8/00

(52) U.S. Cl. CPC A61C 13/0004; A61C 13/0006; A61C 8/0066; A61C 8/009

(57) ABSTRACT

The present disclosure describes technical solutions to various technical problems facing generation of an angulated screw channel for dental implant. An improved screw channel model may be generated based on various inputs. The inputs may include dental implant parameters such as a screw channel length and a variable height. The inputs may also include dental screw parameters associated with a dental screw type, such as a screwhead diameter and a screwhead height. Using these inputs, the improved angulated screw channel model may be generated. By generating a model based on these input parameters, the resulting screw channel model allows the dental screw to be inserted and secured while reducing or minimizing a screw hole size and a screw channel volume.

### CLAIM OF PRIORITY

This application claims the benefit of U.S. Provisional Patent Application Ser. No. 63/270,021, filed on Oct. 20, 2021, the benefit of priority of which is claimed hereby, and which is incorporated by reference herein in its entirety.

### FIELD

The present disclosure is directed to devices and methods for use with dental implant systems.

### BACKGROUND

Digital dentistry has been developed to help dentists and dental assistants in performing dental procedures. Digital dentistry may include computer-aided dentistry, which may be used to design dental implants, dental implant restorations, dental implant models, surgical guides, and other dental procedure devices. An example of computer-aided dentistry is U.S. Pat. No. 8,185,224, which describes manufacturing dental implant components using scanning and computer-aided design.

One form of computer-aided dentistry includes selecting a screw channel for a dental implant. However, existing screw channel solutions typically include an operator selecting a screw channel model from among a number of previously generated screw channel models, then testing the model to verify that a particular dental screw will be able to be inserted through the channel to secure the dental implant. This guess-and-check method is inefficient, as there is no guarantee that a particular screw channel will be compatible with a given screw, and the screw channel size is often selected to be larger than needed to accommodate a given screw. What is needed is an improved screw channel solution.

### BRIEF DESCRIPTION OF THE DRAWINGS

FIG. 1 illustrates four example screw channel forms.

FIGS. 2A-2C illustrate a minimal thickness required around a screw channel.

FIGS. 3A-3B illustrate screw channels

FIG. 4 illustrates a parallel screw channel form.

FIGS. 5A-5B illustrate long hole benefits.

FIG. 6 illustrates schematic overview of an angulated screw channel and base.

FIG. 7 illustrates a dental implant crown and base.

FIG. 8 illustrates hexolobular screwdrivers.

FIG. 9 illustrates hex screwdrivers.

FIG. 10 illustrates various dimension screwdrivers.

FIG. 11 illustrates a dental implant angulated screw channel rotation.

FIG. 12 illustrates a flow chart showing dental screw channel model technique.

FIG. 13 illustrates generally an example of a block diagram of a machine upon which any one or more of the techniques (e.g., methodologies) discussed herein may perform.

### DETAILED DESCRIPTION

The present disclosure describes technical solutions to various technical problems facing generation of an angulated screw channel for dental implant. An improved screw channel model may be generated based on various inputs. The inputs may include dental implant parameters such as a screw channel length and a variable height. The inputs may also include dental screw parameters associated with a dental screw type, such as a screwhead diameter and a screwhead height. Using these inputs, the improved angulated screw channel model may be generated. By generating a model based on these input parameters, the resulting screw channel model allows the dental screw to be inserted and secured while reducing or minimizing a screw hole size and a screw channel volume.

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

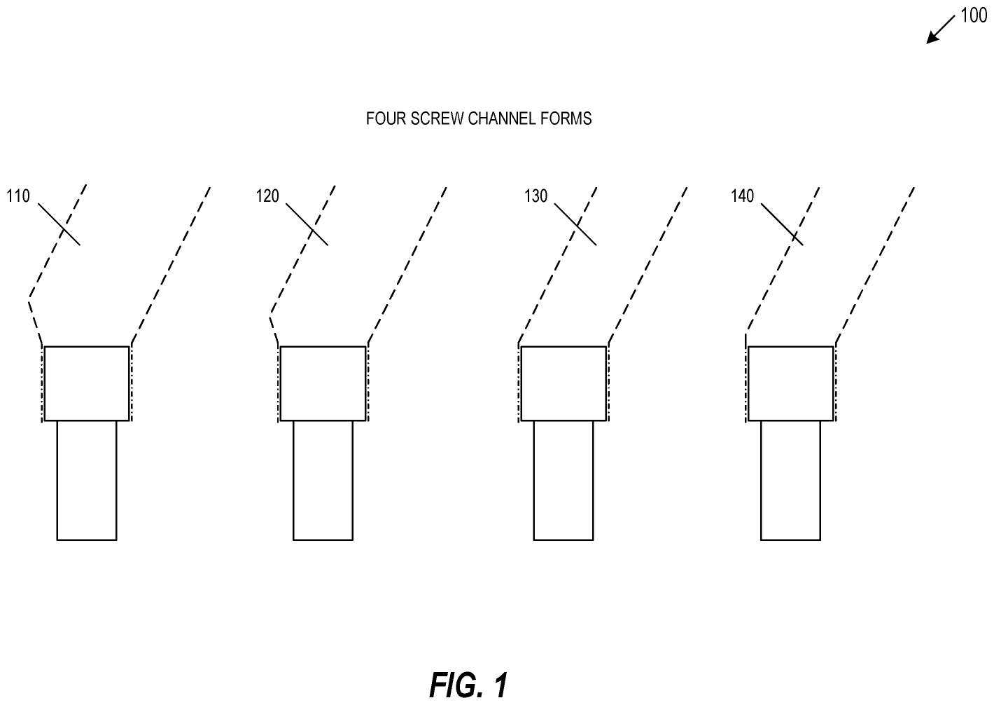

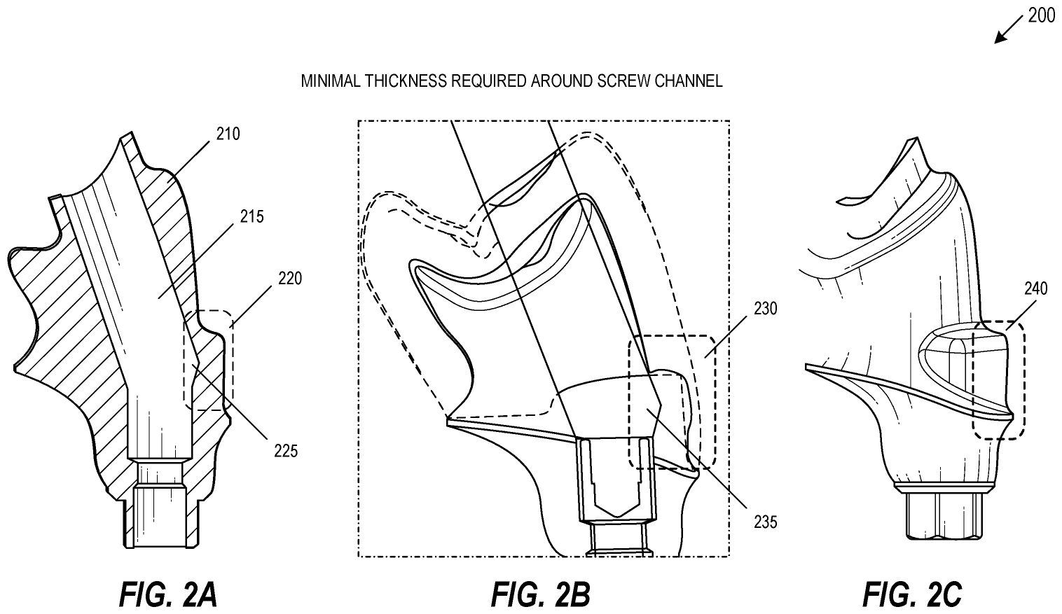

FIG. 1 illustrates four example screw channel forms 100. Each of these screw channel forms 110-140 may be used to provide a screw channel through a dental implant into a dental implant base. Each of these forms is fixed, and is not varied according to angulation or selection of a specific dental implant within a computer-aided design (CAD) or computer-aided modeling (CAM) library of dental implants. These four forms may not cover all requirements. In an example, form 110 may provide the widest screw channel from among the four example screw channel forms, however form 110 may not be big enough for all required geometries or screws. Form 120 may provide a narrower channel than form 110, but both may exhibit unwanted geometries due to minimal thickness requirements shown in FIGS. 2A-2C. Additionally, these four example screw channel forms do not guarantee insertion of the screw to secure the dental implant.

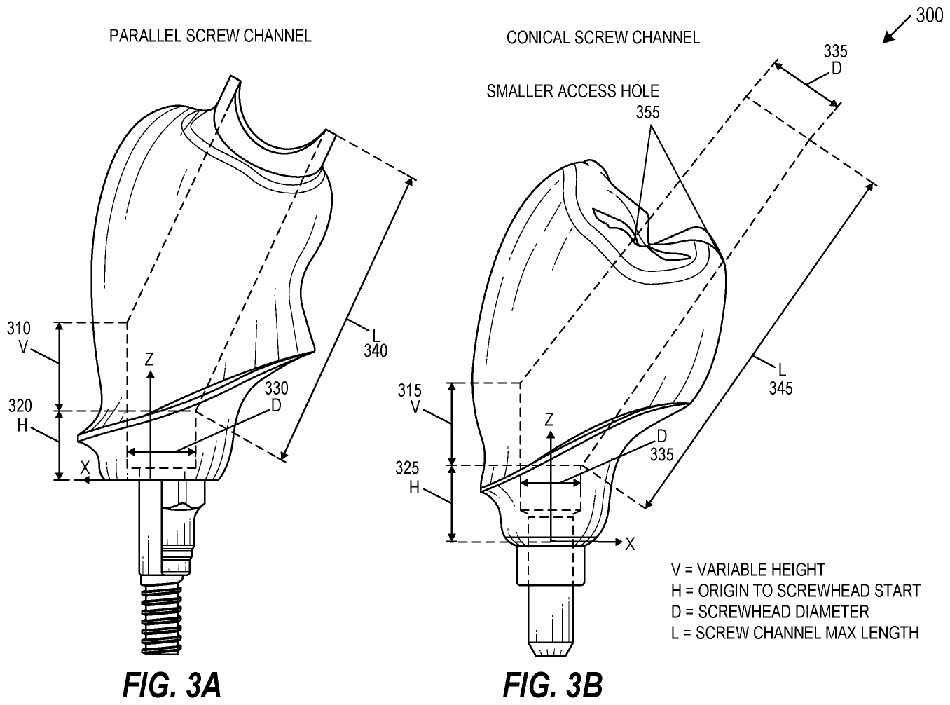

FIGS. 2A-2C illustrate a minimal thickness required around a screw channel 200. A minimal material thickness may be required around each screw channel, such as to provide sufficient structural strength in the dental implant. FIG. 2A shows a 2D cross-sectional drawing of a structural safety region 210 surrounding a screw channel 215. The structural safety region 210 includes a protruding dental implant shelf 220 generated because of the minimal material thickness required to support the dental implant around the internal angled screw channel protrusion 225. Similarly, FIG. 2B shows a 2D cross-sectional drawing that includes a protruding dental implant shelf 230 generated because of the minimal material thickness required to support the dental implant around the internal angled screw channel protrusion 235. FIG. 3B shows a 3D drawing of protruding dental implant shelf 240.

FIGS. 3A-3B illustrate two screw channels 300, including a parallel screw channel form shown in FIG. 3A and a conical screw channel form shown in FIG. 3B. The parallel screw channel shown in FIG. 3A may be defined by various input parameters, including a variable height 310, a screwhead height 320, a screwhead diameter 330, and a screw channel maximum length 340. Similarly, the conical screw channel shown in FIG. 3B may be defined by a variable height 315, a screwhead height 325, a screwhead diameter 335, and a screw channel maximum length 345. As shown in FIG. 3B, the conical variant provides a smaller access hole 355. These screw channels 300 allow for dental screws to be inserted through each of the two screw channels 300 and used to secure a dental implant.

These screw channels 300 may be generated based on the input parameters, and may be output as dental screw channel model CAD files, such as a stereolithography (STL) files. The output dental screw channel model may include various model parameters to accommodate a dental screw while minimizing the screw channel volume. In an example, each screw channel is open on both ends, has an associated height and diameter, the triangulation of the screw channel is not too rough, there are no open areas or overlapping triangles, and the channel is long enough for screws and screwdrivers. These screw channels 300 may be used with one-piece abutment/bridges from bucks, such as for two-piece abutment/bridges. These screw channels 300 allow for standard dental screws to be inserted through the screw channels 300, and reduce or eliminate the need for special screws or additional fastening devices.

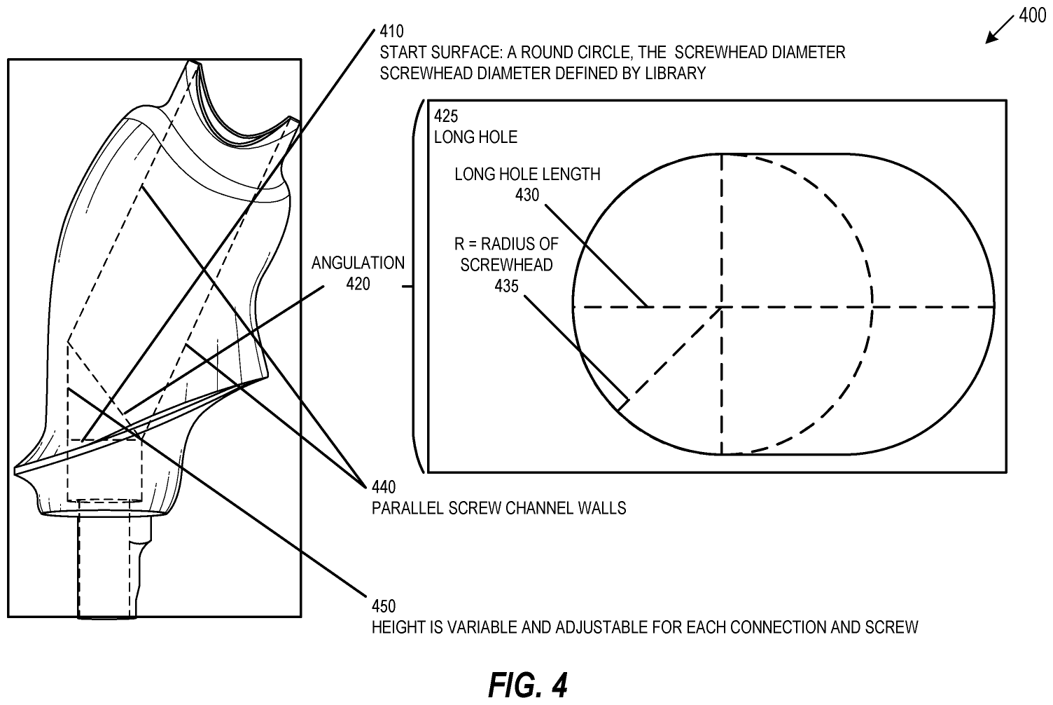

FIG. 4 illustrates a parallel screw channel form 400. The parallel screw channel form 400 may include a start surface 410, which may include a circle whose diameter is based on the screwhead diameter. The screwhead diameter may be an input used by a CAD dental implant library. As shown in FIG. 4, in relation to the angulation 420, a long hole 425 is created. The long hole 425 may have an associated long hole length 430 and an associated screwhead radius of curvature 435. The long hole radius of curvature 435 may be equal to or based on the screw head radius. The screw channel wall 440 may be substantially or perfectly parallel (e.g., forming a cylindrical shape) with a cross section of the same dimensions as the long hole 425. The parallel screw channel form 400 may have an associated height 450, where the height 450 may be variable and adjustable for each connection and screw to provide the ability to reduce or minimize the size of the long hole 425 and volume of the parallel screw channel form 400.

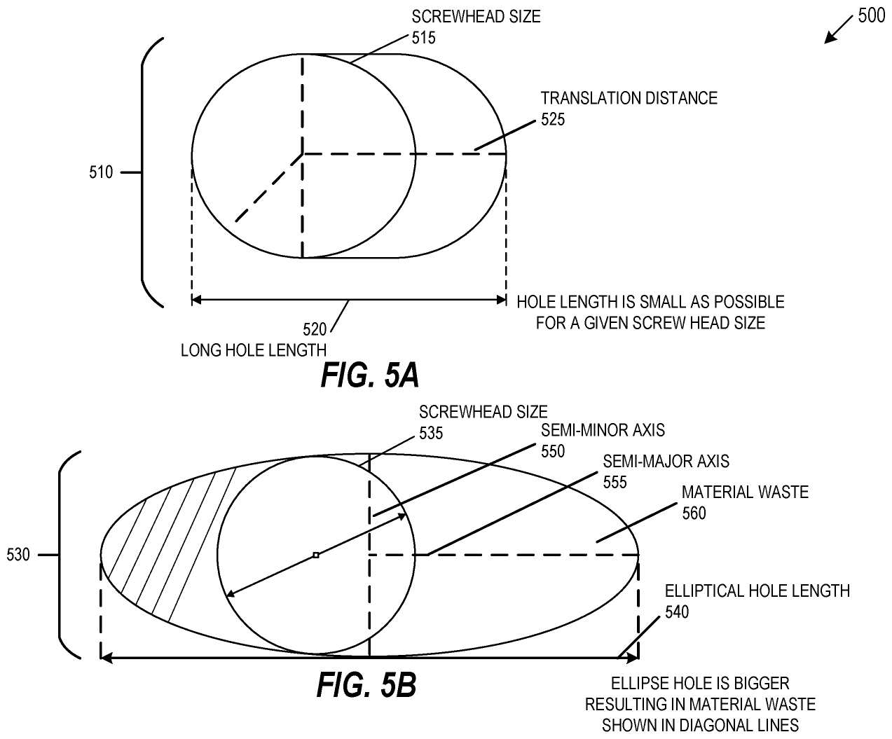

FIGS. 5A-5B illustrate long hole benefits 500. The present improved angulated screw channel includes a long hole 510. The long hole 510 has an associated radius of curvature defined by the screwhead size 515, and has an associated long hole length 520. The geometry of the long hole 510 may be based on the screwhead size 515 translated horizontally for a translation distance 525. The elliptical hole 530 may also be based on a corresponding screwhead size 535 and have an associated elliptical hole length 540. The geometry of the elliptical hole 530 may be based on a geometrically elliptical area whose semi-minor axis 550 is based on accommodating a diameter of the screwhead size 535 and whose semi-major axis 555 is double the elliptical hole length 540. In contrast with the elliptical hole 530, the non-elliptical long hole 510 may be used to provide provides the smallest possible hole that may fit the screw length and screwhead size 515. The elliptical hole 530 requires greater area, which results in more material waste 560 and increases machining complexity.

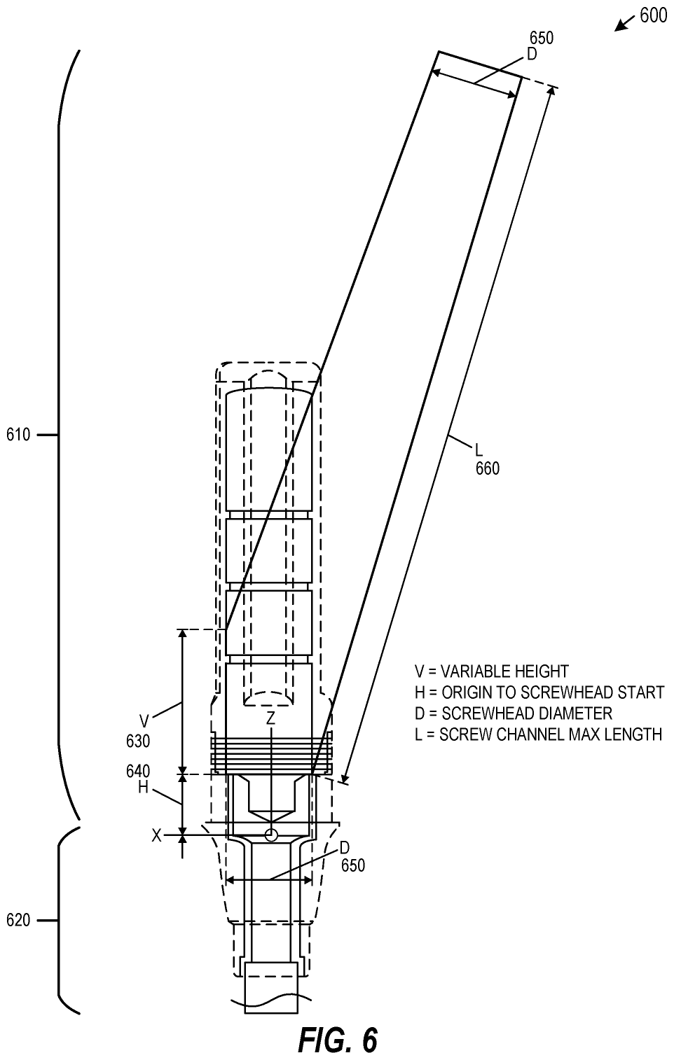

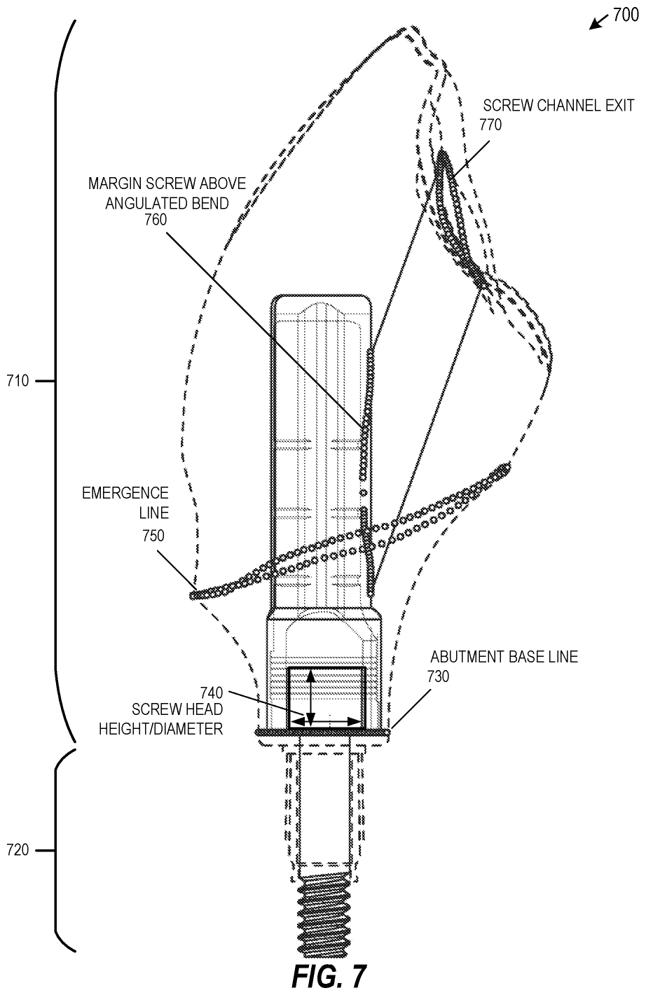

FIG. 6 illustrates schematic overview 600 of an angulated screw channel and base. The dental implant shown in schematic overview 600 may include an angulated screw channel 610 that is attached to a rigid implant base 620, such as may be used in a two-piece abutment implant or hybrid abutment implant. The schematic overview 600 also includes dimensions that may be used as inputs for the generation of an output conical screw channel model or an output parallel screw channel model. The inputs may include a variable height V 630, a height H 640 defining a distance from origin to end of screwhead angulation start, a screwhead diameter D 650 (e.g., as defined by a dental implant library), a maximal screw channel length L 660. In addition to these angulated screw channel form dimensions, an input screw channel type may be used to indicate whether the screw channel model to be generated includes a parallel screw channel model or a conical screw channel model. An example output model generated by angulated screw channel form dimensions and the input screw channel type is shown in FIG. 7.

FIG. 7 illustrates a dental implant 700, including crown 710 and base 720. FIG. 7 further illustrates several three-dimensional (3D) parameters for a screw channel model, such as the abutment base line 730, the height and diameter of the screw head 740, the emergence line 750, the margin screw above angulated bend 760 (e.g., for use in DentalCAD or Exocad), and the screw channel exit 770. A model including these parameters may be output as an STL or other CAD or CAM file. The output file may be displayed to a dental surgeon for review and further editing. The model may be transferred to a robotic dental implant milling machine for milling the angulated screw channel, to a robotic dental drill for drilling the angulated screw channel, or may be transferred to 3D printer for printing one or more of the crown 710 with screw channel and base 720.

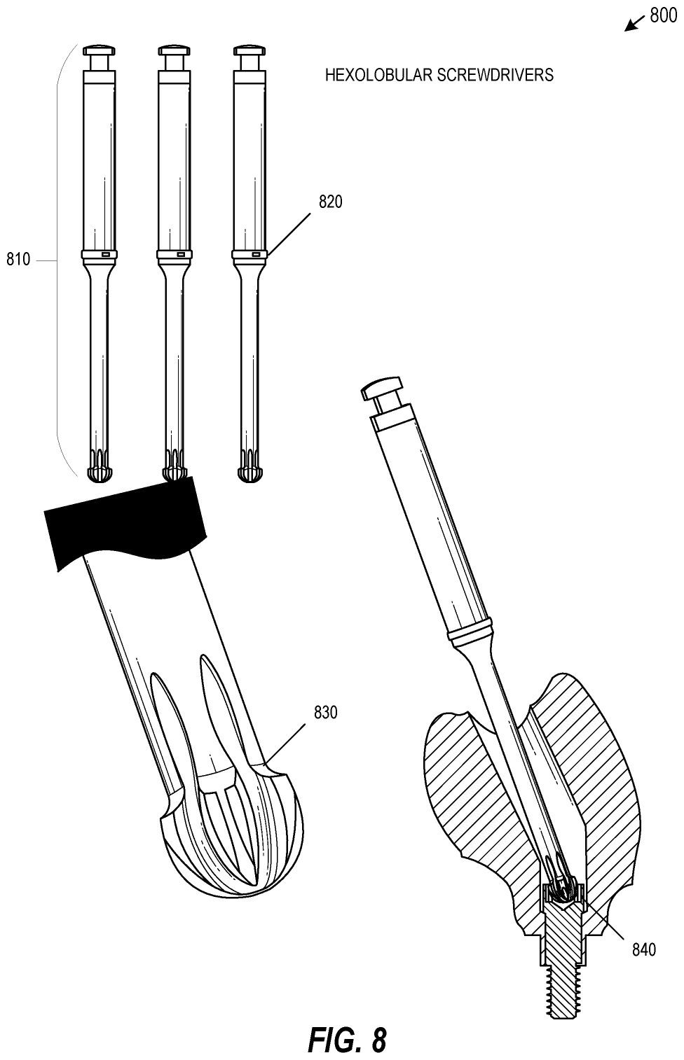

FIG. 8 illustrates hexolobular screwdrivers 800. The hexolobular screwdrivers 800 may be used to install a hexolobular screw through one of the angulated screw channels defined herein. Various screw types (e.g., hexolobular screws, hex screws) may be used based on different screw original equipment manufacturers (OEMs), and each screw type may have an associated screwdriver. A group of hexolobular screwdrivers 810 may each have a different length, diameter, or other geometry for use with different diameter hexolobular screws. Each screwdriver within a group of hexolobular screwdrivers 810 may include a visual indicator 820 (e.g., color coding) to indicate the type of screwdriver. Each of the hexolobular screwdrivers may have a hexolobular head 830 associated with a corresponding hexolobular screw 840.

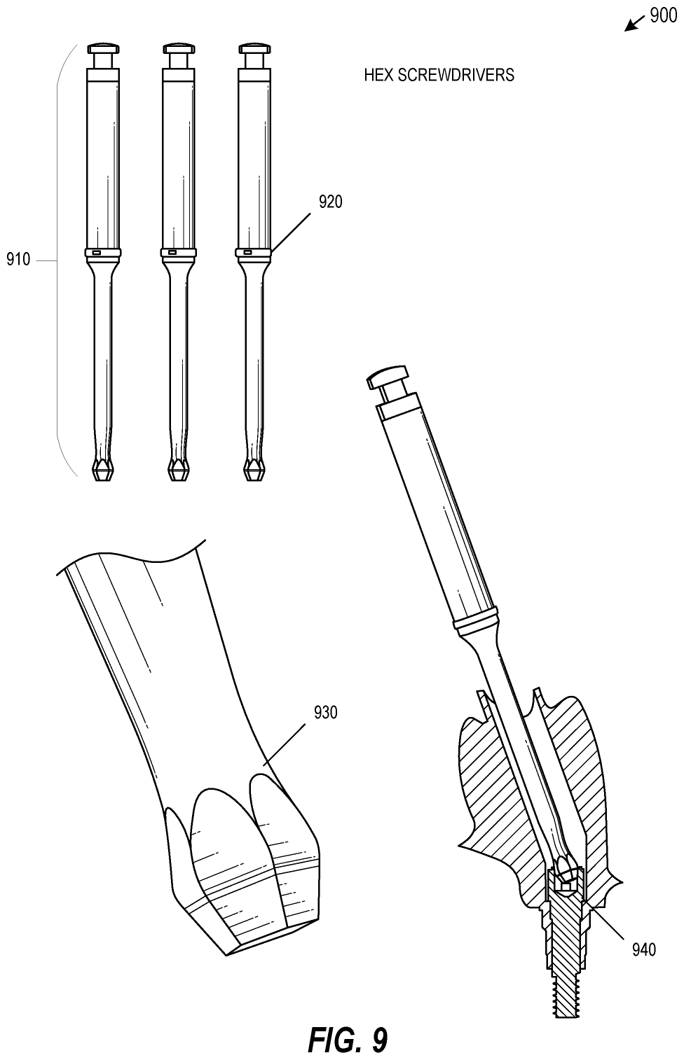

FIG. 9 illustrates hex screwdrivers 900. The hex screwdrivers 900 may be used to install a hex screw through one of the angulated screw channels defined herein. A group of hex screwdrivers 910 may each have a different length, diameter, or other geometry for use with different diameter hex screws. Each screwdriver within a group of hex screwdrivers 910 may include a visual indicator 920 to indicate the type of screwdriver. Each of the hex screwdrivers may have a hex head 930 associated with a corresponding hex screw 940.

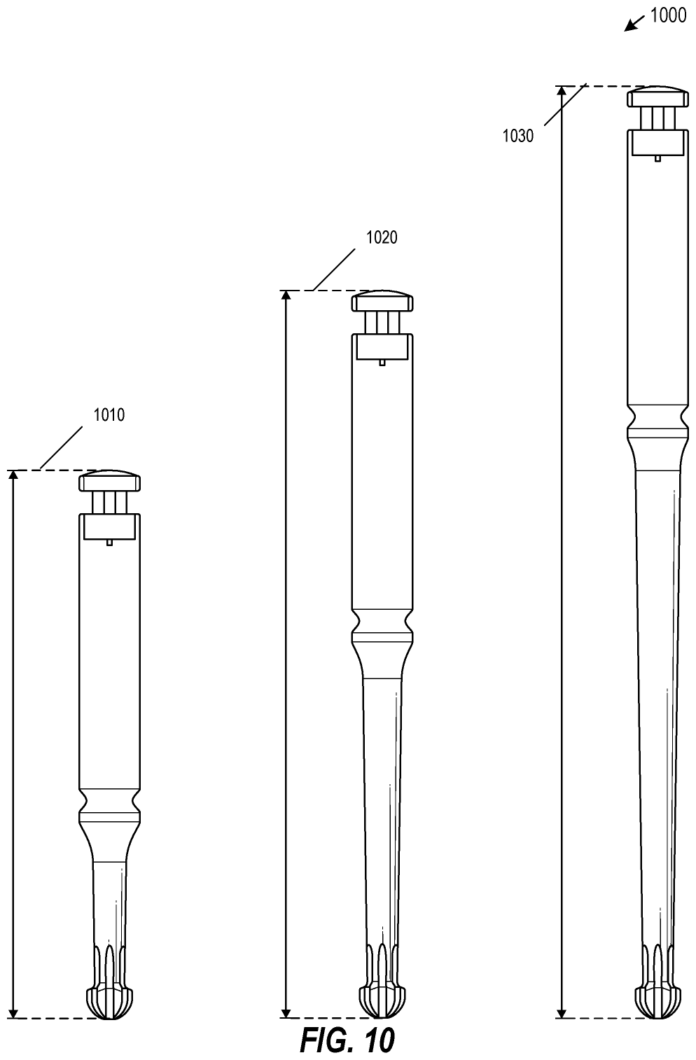

FIG. 10 illustrates various dimension screwdrivers 1000. Each of the hexolobular or hex screwdrivers may have an associated height or length, such as a short driver 1010, medium driver 1020, and long driver 1030. Each of the hexolobular or hex screwdrivers may have an associated alphanumeric identification or other visual indicator, which may provide a visual indication of the length, head size, associated screw type, or other information about screwdrivers 1000.

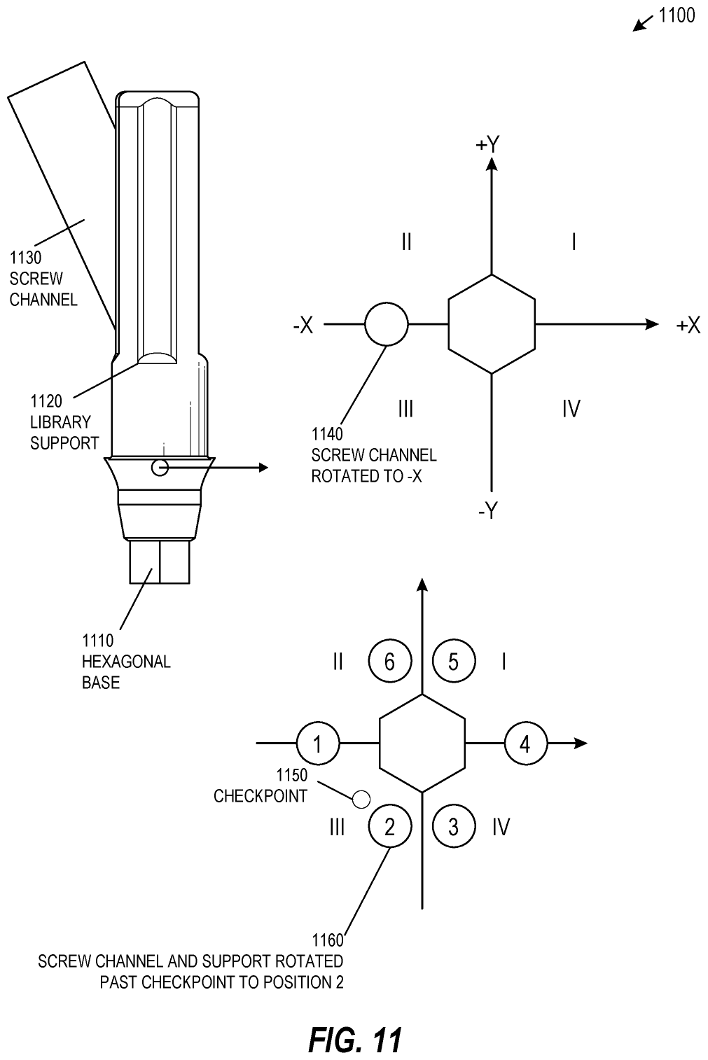

FIG. 11 illustrates a dental implant angulated screw channel rotation 1100. Each dental implant may have a hexagonal base 1110 (e.g., titanium base), a library support 1120 fixedly attached to the hexagonal base 1110, and a screw channel 1130 extending from and supported by the library support 1120. For installation of the dental implant, the angulated screw channel is rotated to a certain position, such as to −X position 1140. In an example, the hexagonal base allows for orienting the screw channel in one of six different positions. The dental implant may have an associated checkpoint 1150, and the angulated screw channel may need to be rotated at least through the checkpoint 1150 to secure the dental implant. As shown in FIG. 11, the angulated screw channel may need to be rotated counterclockwise past the checkpoint 1150 to the second hexagonal position 1160 (e.g., hexagonal position 2) to secure the dental implant. While FIG. 11 illustrates a two-piece abutment dental implant that may have a hexagonal base 1110, other embodiments may include an angulated screw channel that may be positioned freely around 360°. In various embodiments, a direct-screwed abutment (e.g., one-piece abutment) and some two-piece abutment designs may include the ability to be positioned freely around 360°.

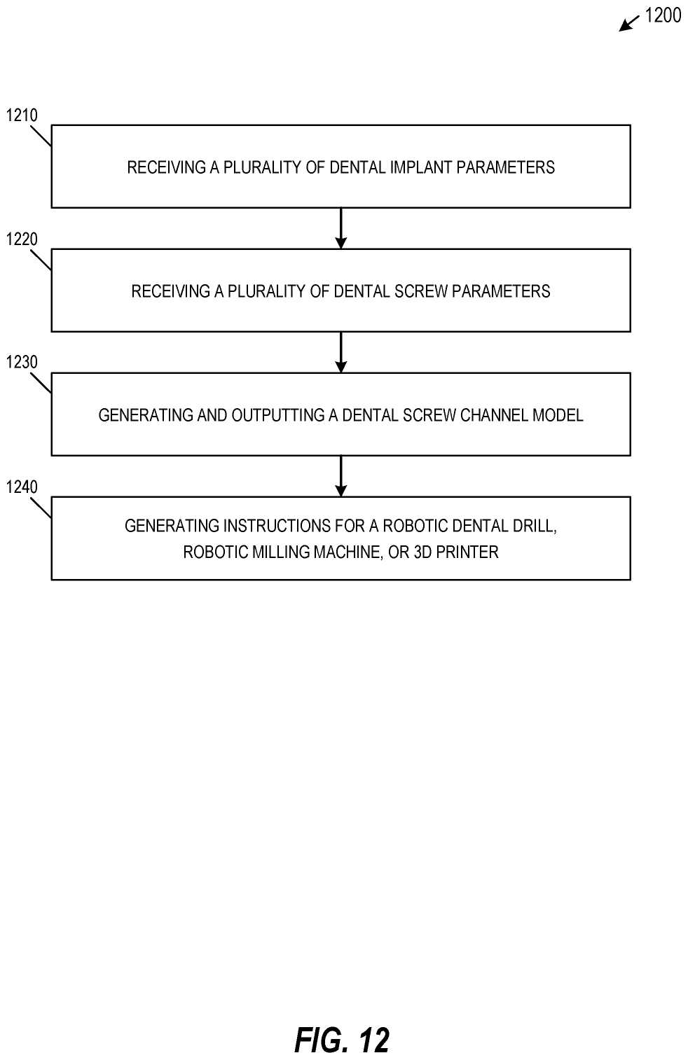

FIG. 12 illustrates a flow chart showing dental screw channel model technique 1200, in accordance with some embodiments. In an embodiment, technique 1200 includes receiving 1210 a plurality of dental implant parameters, where the plurality of dental implant parameters includes a screw channel length and a variable height. Technique 1200 further includes receiving 1220 a plurality of dental screw parameters associated with a dental screw type, where the plurality of dental screw parameters includes a screwhead diameter and a screwhead height. Technique 1200 further includes generating and outputting 1230 a dental screw channel model based on the plurality of dental implant parameters and on the plurality of dental screw parameters. The dental screw channel model includes a dental abutment baseline geometry, a dental emergence geometry, a screwhead angulation geometry, and a screw channel exit geometry.

Technique 1200 may include generating 1240 instructions for a robotic dental implant milling machine, for a robotic dental drill, or for a 3D printer based on the dental screw channel model. The plurality of dental implant parameters may further include a screw channel type, the screw channel type including a conical screw channel or a parallel screw channel. The screwhead angulation geometry may include a non-ellipsoid long hole geometry. The non-ellipsoid long hole geometry may include a radius of curvature based on the screwhead diameter. The variable height may be selected based on a screw length associated with a dental screw, the screwhead diameter, and the screwhead height to minimize the non-ellipsoid long hole geometry.

In an example, the generation 1230 of the dental screw channel model may be further based on a received dental implant base geometry. The dental screw channel model may further include a dental implant rotation position, which may be based on a received dental implant rotation checkpoint position. The dental implant base geometry may include a n-sided polygon geometry. The dental implant rotation position may include a first position on the n-sided polygon geometry following the dental implant rotation checkpoint position.

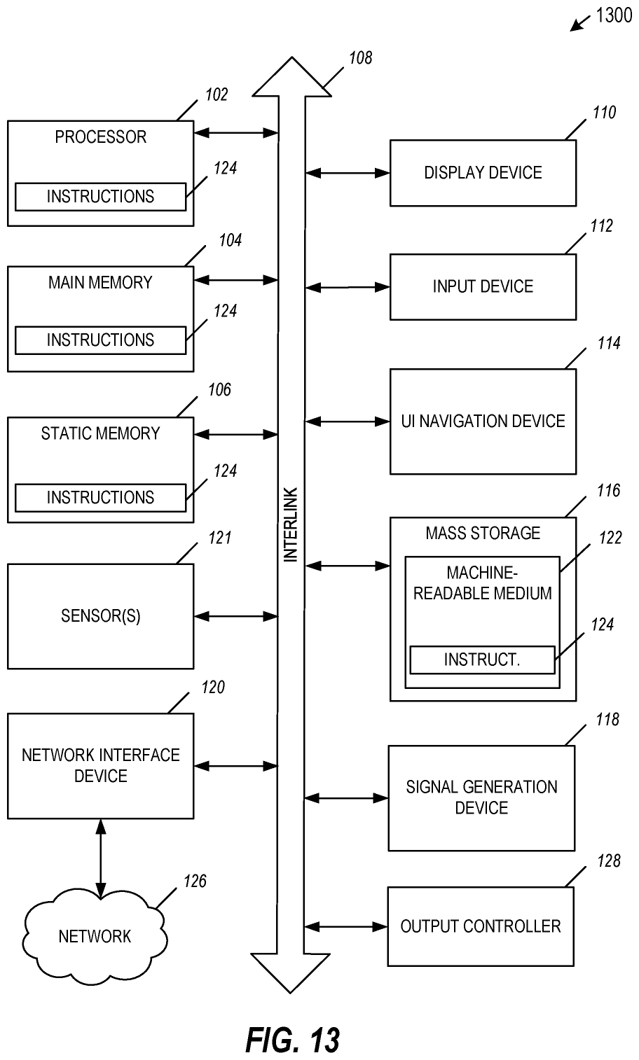

FIG. 13 illustrates generally an example of a block diagram of a machine 1300 upon which any one or more of the techniques (e.g., methodologies) discussed herein may perform in accordance with some embodiments. In alternative embodiments, the machine 1300 may operate as a standalone device or may be connected (e.g., networked) to other machines. In a networked deployment, the machine 1300 may operate in the capacity of a server machine, a client machine, or both in server-client network environments. The machine 1300 may be a personal computer (PC), a tablet PC, a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or like mechanisms. Such mechanisms are tangible entities (e.g., hardware) capable of performing specified operations when operating. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. For example, under operation, the execution units may be configured by a first set of instructions to implement a first set of features at one point in time and reconfigured by a second set of instructions to implement a second set of features.

Machine (e.g., computer system) 1300 may include a hardware processor 1302 (e.g., a central processing unit (CPU), a graphics processing unit (GPU), a hardware processor core, or any combination thereof), a main memory 1304 and a static memory 1306, some or all of which may communicate with each other via an interlink (e.g., bus) 1308. The machine 1300 may further include a display unit 1310, an alphanumeric input device 1312 (e.g., a keyboard), and a user interface (UI) navigation device 1314 (e.g., a mouse). In an example, the display unit 1310, alphanumeric input device 1312 and UI navigation device 1314 may be a touch screen display. The display unit 1310 may include goggles, glasses, an augmented reality (AR) display, a virtual reality (VR) display, or another display component. For example, the display unit may be worn on a head of a user and may provide a heads-up-display to the user. The alphanumeric input device 1312 may include a virtual keyboard (e.g., a keyboard displayed virtually in a VR or AR setting.

The machine 1300 may additionally include a storage device (e.g., drive unit) 1316, a signal generation device 1318 (e.g., a speaker), a network interface device 1320, and one or more sensors 1321, such as a global positioning system (GPS) sensor, compass, accelerometer, or other sensor. The machine 1300 may include an output controller 1328, such as a serial (e.g., universal serial bus (USB), parallel, or other wired or wireless (e.g., infrared (IR), near field communication (NFC), etc.) connection to communicate or control one or more peripheral devices.

The storage device 1316 may include a machine readable medium 1322 that is non-transitory on which is stored one or more sets of data structures or instructions 1324 (e.g., software) embodying or utilized by any one or more of the techniques or functions described herein. The instructions 1324 may also reside, completely or at least partially, within the main memory 1304, within static memory 1306, or within the hardware processor 1302 during execution thereof by the machine 1300. In an example, one or any combination of the hardware processor 1302, the main memory 1304, the static memory 1306, or the storage device 1316 may constitute machine readable media.

While the machine readable medium 1322 is illustrated as a single medium, the term “machine readable medium” may include a single medium or multiple media (e.g., a centralized or distributed database, or associated caches and servers) configured to store the one or more instructions 1324.

The term “machine readable medium” may include any medium that is capable of storing, encoding, or carrying instructions for execution by the machine 1300 and that cause the machine 1300 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium via the network interface device 1320 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, as the personal area network family of standards known as Bluetooth® that are promulgated by the Bluetooth Special Interest Group, peer-to-peer (P2P) networks, among others. In an example, the network interface device 1320 may include one or more physical jacks (e.g., Ethernet, coaxial, or phone jacks) or one or more antennas to connect to the communications network 1326. In an example, the network interface device 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1300, and includes digital or analog communications signals or other intangible medium to facilitate communication of such software.

Each of these non-limiting examples may stand on its own, or may be combined in various permutations or combinations with one or more of the other examples.

Example 1 is a method for generating an angulated dental screw channel model, the method comprising: receiving a plurality of dental implant parameters, the plurality of dental implant parameters including a screw channel length and a variable height; receiving a plurality of dental screw parameters associated with a dental screw type, the plurality of dental screw parameters including a screwhead diameter and a screwhead height; and generating and outputting an angulated dental screw channel model based on the plurality of dental implant parameters and on the plurality of dental screw parameters, the angulated dental screw channel model to provide an angulated screw channel without requiring an internal angled screw channel protrusion.

In Example 2, the subject matter of Example 1 includes, wherein the angulated dental screw channel model includes a dental abutment baseline geometry, a dental emergence geometry, a screwhead angulation geometry, and a screw channel exit geometry.

In Example 3, the subject matter of Examples 1-2 includes, generating instructions for a robotic dental implant milling machine based on the angulated dental screw channel model.

In Example 4, the subject matter of Examples 1-3 includes, generating instructions for a 3D printed model based on the angulated dental screw channel model.

In Example 5, the subject matter of Examples 1-4 includes, the plurality of dental implant parameters further including a screw channel type, the screw channel type including a conical screw channel or a parallel screw channel.

In Example 6, the subject matter of Examples 2-5 includes, wherein the screwhead angulation geometry includes a non-ellipsoid long hole geometry, the non-ellipsoid long hole geometry including a radius of curvature based on the screwhead diameter.

In Example 7, the subject matter of Example 6 includes, wherein the variable height is selected based on a screw length associated with a dental screw, the screwhead diameter, and the screwhead height to minimize the non-ellipsoid long hole geometry.

In Example 8, the subject matter of Examples 2-7 includes, receiving a dental implant base geometry, wherein: generating the angulated dental screw channel model is further based on the dental implant base geometry; and the angulated dental screw channel model further includes a dental implant rotation position.

In Example 9, the subject matter of Example 8 includes, receiving a dental implant rotation checkpoint position, wherein: the dental implant base geometry includes a n-sided polygon geometry; and the dental implant rotation position includes a first position on the n-sided polygon geometry following the dental implant rotation checkpoint position.

Example 10 is a device for generating an angulated dental screw channel model, the device comprising: a processor; and a memory device coupled to the processor and having a program stored thereon for execution by the processor to perform operations comprising: receiving a plurality of dental implant parameters, the plurality of dental implant parameters including a screw channel length and a variable height; receiving a plurality of dental screw parameters associated with a dental screw type, the plurality of dental screw parameters including a screwhead diameter and a screwhead height; and generating and outputting an angulated dental screw channel model based on the plurality of dental implant parameters and on the plurality of dental screw parameters, the angulated dental screw channel model to provide an angulated screw channel without requiring an internal angled screw channel protrusion.

In Example 11, the subject matter of Example 10 includes, wherein the angulated dental screw channel model includes a dental abutment baseline geometry, a dental emergence geometry, a screwhead angulation geometry, and a screw channel exit geometry.

In Example 12, the subject matter of Examples 10-11 includes, the operations further including causing a robotic dental implant milling machine to mill a dental screw channel based on the angulated dental screw channel model.

In Example 13, the subject matter of Examples 10-12 includes, the operations further including causing a 3D printer to form a dental implant with an internal dental screw channel based on the angulated dental screw channel model.

In Example 14, the subject matter of Examples 10-13 includes, the plurality of dental implant parameters further including a screw channel type, the screw channel type including a conical screw channel or a parallel screw channel.

In Example 15, the subject matter of Examples 11-14 includes, wherein the screwhead angulation geometry includes a non-ellipsoid long hole geometry, the non-ellipsoid long hole geometry including a radius of curvature based on the screwhead diameter.

In Example 16, the subject matter of Example 15 includes, wherein the variable height is selected based on a screw length associated with a dental screw, the screwhead diameter, and the screwhead height to minimize the non-ellipsoid long hole geometry.

In Example 17, the subject matter of Examples 11-16 includes, the operations further including receiving a dental implant base geometry, wherein: generating the angulated dental screw channel model is further based on the dental implant base geometry; and the angulated dental screw channel model further includes a dental implant rotation position.

In Example 18, the subject matter of Example 17 includes, the operations further including receiving a dental implant rotation checkpoint position, wherein: the dental implant base geometry includes a n-sided polygon geometry, and the dental implant rotation position includes a first position on the n-sided polygon geometry following the dental implant rotation checkpoint position.

Example 19 is a non-transitory computer-readable storage medium comprising one or more programs for execution by one or more processors of a device, the one or more programs including instructions which, when executed by the one or more processors, cause the device to: receive a plurality of dental implant parameters, the plurality of dental implant parameters including a screw channel length and a variable height; receive a plurality of dental screw parameters associated with a dental screw type, the plurality of dental screw parameters including a screwhead diameter and a screwhead height; and generate and outputting an angulated dental screw channel model based on the plurality of dental implant parameters and on the plurality of dental screw parameters, the angulated dental screw channel model to provide an angulated screw channel without requiring an internal angled screw channel protrusion.

In Example 20, the subject matter of Example 19 includes, wherein the angulated dental screw channel model includes a dental abutment baseline geometry, a dental emergence geometry, a screwhead angulation geometry, and a screw channel exit geometry.

In Example 21, the subject matter of Examples 19-20 includes, the instructions further causing the device to generate instructions for a robotic dental implant milling machine based on the angulated dental screw channel model.

In Example 22, the subject matter of Examples 19-21 includes, the instructions further causing the device to generate instructions for a 3D printer based on the angulated dental screw channel model.

In Example 23, the subject matter of Examples 19-22 includes, the plurality of dental implant parameters further including a screw channel type, the screw channel type including a conical screw channel or a parallel screw channel.

In Example 24, the subject matter of Examples 20-23 includes, wherein the screwhead angulation geometry includes a non-ellipsoid long hole geometry, the non-ellipsoid long hole geometry including a radius of curvature based on the screwhead diameter.

In Example 25, the subject matter of Example 24 includes, wherein the variable height is selected based on a screw length associated with a dental screw, the screwhead diameter, and the screwhead height to minimize the non-ellipsoid long hole geometry.

In Example 26, the subject matter of Examples 20-25 includes, the instructions further causing the device to receive a dental implant base geometry, wherein: generating the angulated dental screw channel model is further based on the dental implant base geometry; and the angulated dental screw channel model further includes a dental implant rotation position.

In Example 27, the subject matter of Example 26 includes, the instructions further causing the device to receive a dental implant rotation checkpoint position, wherein: the dental implant base geometry includes a n-sided polygon geometry; and the dental implant rotation position includes a first position on the n-sided polygon geometry following the dental implant rotation checkpoint position.

Example 28 is at least one machine-readable medium including instructions that, when executed by processing circuitry, cause the processing circuitry to perform operations to implement of any of Examples 1-27.

Example 29 is an apparatus comprising means to implement of any of Examples 1-27.

Example 30 is a system to implement of any of Examples 1-27.

Example 31 is a method to implement of any of Examples 1-27.

### VARIOUS NOTES

The above detailed description includes references to the accompanying drawings, which form a part of the detailed description. The drawings show, by way of illustration, specific embodiments in which the invention can be practiced. In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document. These embodiments are also referred to herein as “examples.” Such examples can include elements in addition to those shown or described. However, the present inventor also contemplates examples in which only those elements shown or described are provided. Moreover, the present inventor also contemplates examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method for generating an angulated dental screw channel model, the method comprising:
receiving a plurality of dental implant parameters, the plurality of dental implant parameters including a screw channel length and a variable height;
receiving a plurality of dental screw parameters associated with a dental screw type, the plurality of dental screw parameters including a screwhead diameter and a screwhead height; and
generating and outputting an angulated dental screw channel model based on the plurality of dental implant parameters and on the plurality of dental screw parameters, the angulated dental screw channel model to provide an angulated screw channel without requiring an internal angled screw channel protrusion.

2. The method of claim 1, wherein the angulated dental screw channel model includes a dental abutment baseline geometry, a dental emergence geometry, a screwhead angulation geometry, and a screw channel exit geometry.

3. The method of claim 1, further including generating instructions for a robotic dental implant milling machine based on the angulated dental screw channel model.

4. The method of claim 1, further including generating instructions for a 3D printed model based on the angulated dental screw channel model.

5. The method of claim 1, the plurality of dental implant parameters further including a screw channel type, the screw channel type including a conical screw channel or a parallel screw channel.

6. The method of claim 2, wherein the screwhead angulation geometry includes a non-ellipsoid long hole geometry, the non-ellipsoid long hole geometry including a radius of curvature based on the screwhead diameter.

7. The method of claim 6, wherein the variable height is selected based on a screw length associated with a dental screw, the screwhead diameter, and the screwhead height to minimize the non-ellipsoid long hole geometry.

8. The method of claim 2, further including receiving a dental implant base geometry, wherein:
generating the angulated dental screw channel model is further based on the dental implant base geometry; and
the angulated dental screw channel model further includes a dental implant rotation position.

9. The method of claim 8, further including receiving a dental implant rotation checkpoint position, wherein:
the dental implant base geometry includes a n-sided polygon geometry; and
the dental implant rotation position includes a first position on the n-sided polygon geometry following the dental implant rotation checkpoint position.

10. A device for generating an angulated dental screw channel model, the device comprising:
a processor; and
a memory device coupled to the processor and having a program stored thereon for execution by the processor to perform operations comprising:
receiving a plurality of dental implant parameters, the plurality of dental implant parameters including a screw channel length and a variable height;
receiving a plurality of dental screw parameters associated with a dental screw type, the plurality of dental screw parameters including a screwhead diameter and a screwhead height; and
generating and outputting an angulated dental screw channel model based on the plurality of dental implant parameters and on the plurality of dental screw parameters, the angulated dental screw channel model to provide an angulated screw channel without requiring an internal angled screw channel protrusion.

11. The device of claim 10, wherein the angulated dental screw channel model includes a dental abutment baseline geometry, a dental emergence geometry, a screwhead angulation geometry, and a screw channel exit geometry.

12. The device of claim 10, the operations further including causing a robotic dental implant milling machine to mill a dental screw channel based on the angulated dental screw channel model.

13. The device of claim 10, the operations further including causing a 3D printer to form a dental implant with an internal dental screw channel based on the angulated dental screw channel model.

14. The device of claim 11, wherein the screwhead angulation geometry includes a non-ellipsoid long hole geometry, the non-ellipsoid long hole geometry including a radius of curvature based on the screwhead diameter.

15. The device of claim 14, wherein the variable height is selected based on a screw length associated with a dental screw, the screwhead diameter, and the screwhead height to minimize the non-ellipsoid long hole geometry.

16. The device of claim 11, the operations further including receiving a dental implant base geometry, wherein:
generating the angulated dental screw channel model is further based on the dental implant base geometry; and
the angulated dental screw channel model further includes a dental implant rotation position.

17. The device of claim 16, the operations further including receiving a dental implant rotation checkpoint position, wherein:
the dental implant base geometry includes a n-sided polygon geometry; and
the dental implant rotation position includes a first position on the n-sided polygon geometry following the dental implant rotation checkpoint position.

18. A non-transitory computer-readable storage medium comprising one or more programs for execution by one or more processors of a device, the one or more programs including instructions which, when executed by the one or more processors, cause the device to;
receive a plurality of dental implant parameters, the plurality of dental implant parameters including a screw channel length and a variable height;
receive a plurality of dental screw parameters associated with a dental screw type, the plurality of dental screw parameters including a screwhead diameter and a screwhead height; and
generate and outputting an angulated dental screw channel model based on the plurality of dental implant parameters and on the plurality of dental screw parameters, the angulated dental screw channel model to provide an angulated screw channel without requiring an internal angled screw channel protrusion.

19. The non-transitory computer-readable storage medium of claim 18, wherein the angulated dental screw channel model includes a dental abutment baseline geometry, a dental emergence geometry, a screwhead angulation geometry, and a screw channel exit geometry.

20. The non-transitory computer-readable storage medium of claim 19, wherein the screwhead angulation geometry includes a non-ellipsoid long hole geometry, the non-ellipsoid long hole geometry including a radius of curvature based on the screwhead diameter.
